(19) United States
(12) Patent Application Publication
(10) Pub. No.: US 2005/0115288 A1
(43) Pub. Date: Jun. 2, 2005

(54) Adjustable locking mechanism

(76) Inventor: Jedediah A. Burmahln, Valencia, CA (US)

Correspondence Address: BARNES & THORNBURG, P.O. BOX 2786, CHICAGO, IL, 60690-2786, US

(21) Appl. No.: 10/726,293

(22) Filed: Dec. 2, 2003

(51) Int. Cl. E05B 65/06

(52) U.S. Cl. 70/127

(57) ABSTRACT

An adjustable locking mechanism including a lock cylinder, a housing, a spindle and a locking pawl configured to rotate with the spindle between lock and unlocked positions. The lock cylinder and spindle are configured to rotate the locking pawl between an unlocked or otherwise disengaged position and a locked or otherwise engaged position and to permit continued rotation of the lock cylinder and spindle after the locking pawl is in the locked or otherwise engaged position to cause the spindle to rotate relative to the locking pawl.

### BACKGROUND

The present disclosure relates to an adjustable locking mechanism for use with any suitable door, drawer or other enclosure.

Latching devices for use in securing doors, drawers and other enclosures in a closed position are known. Such devices may include a pawl or other latching member for engaging a wall or other structure associated with the door, drawer or other enclosure. Depending on the design of the device, such pawl or other latching member may be movable rotationally or translationally to engage and disengage such structure.

The present disclosure relates to an adjustable locking mechanism that can be used with any suitable door, drawer, or other enclosure. The adjustable locking member includes a housing and a latching pawl rotatable relative to the housing. The adjustable locking mechanism can be used, for example, on recreational or other vehicles such as, for example, on cabinet doors, cabin doors, drawers or luggage or other doors or compartments in vehicles. The adjustable locking mechanism can also be used in any other industrial, business, personal, travel or other vehicle or non-vehicle application. The present disclosure also relates to a method for engaging and disengaging the door, drawer or other enclosure with the structure associated with the door, drawer or other enclosure

Additional features of the present disclosure will become apparent to those skilled in the art upon consideration of the following detailed description of illustrative embodiments of the disclosure.

### BRIEF DESCRIPTION OF THE DRAWINGS

The detailed description particularly refers to the accompanying figures in which:

FIG. 1 is a side elevation view of an adjustable locking mechanism;

FIG. 2 is a top view of the adjustable locking mechanism of FIG. 1;

FIG. 3 is an exploded perspective view of the adjustable locking mechanism of FIG. 1;

FIG. 4 is a perspective view of the housing of the adjustable locking mechanism of FIG. 1;

FIG. 5 is an enlarged perspective view of the cap of the adjustable locking mechanism of FIG. 1;

FIG. 6 is a top plan view of the cap of the adjustable locking mechanism of FIG. 1 and as shown in FIG. 5;

FIG. 7 is a perspective view of a housing of an adjustable locking mechanism in accordance with an other embodiment of the present disclosure;

FIG. 8 is a side plan view of the housing of the adjustable locking mechanism of FIG. 7;

FIG. 9 is an enlarged perspective view of a cap of an adjustable locking mechanism in accordance with an other embodiment configured to engage the housing of FIG. 7; and

FIG. 10 is a top plan view of the cap of FIG. 9.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the number and arrangements of components set forth in the following description or illustrated in the drawings.

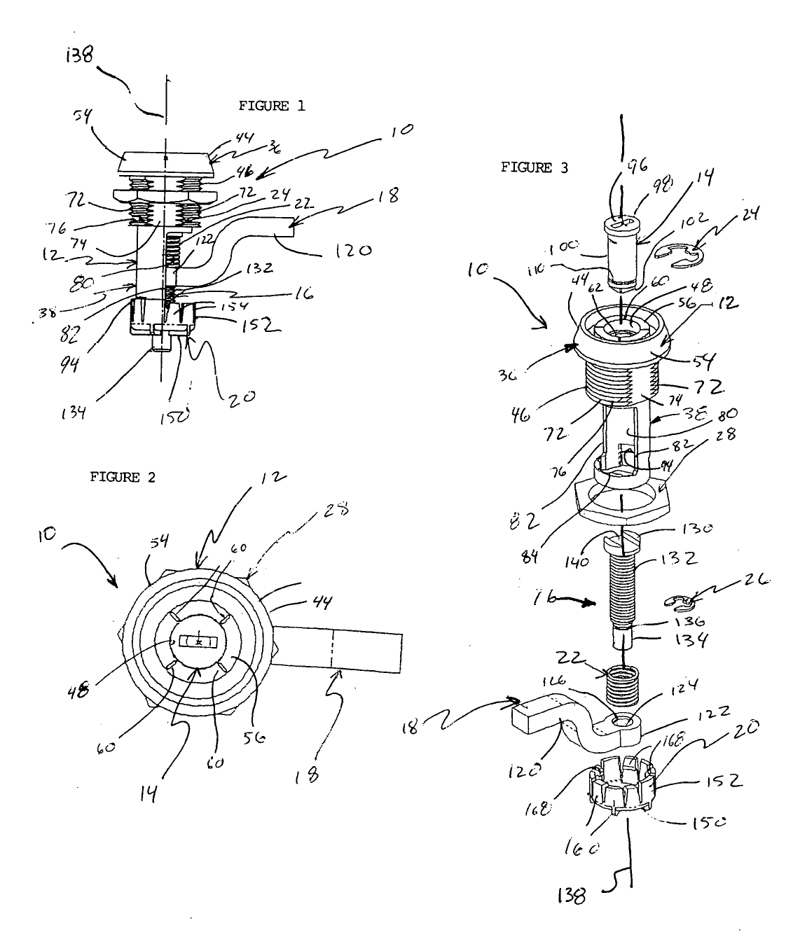

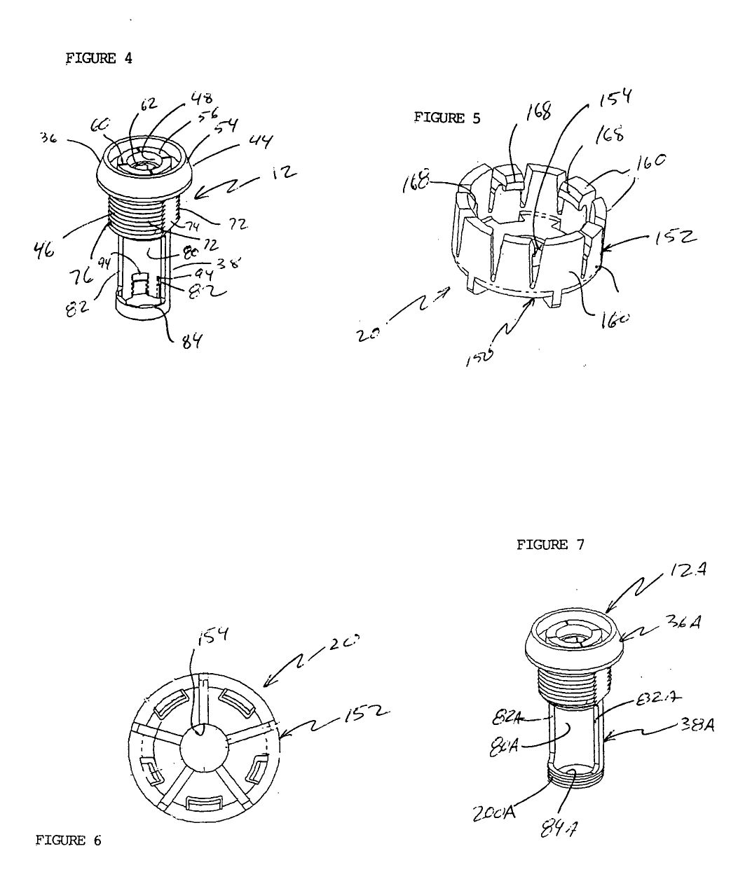

FIGS. 1-6 provide an illustrative embodiment of an adjustable locking mechanism 10 comprising a housing 12, a lock cylinder 14, a threaded spindle 16, a latching pawl 18, a cap 20, a spring 22, a pair of retainers 24 and 26, and a lock nut 28. The adjustable locking mechanism 10 is configured to be installed on a door or drawer or any other suitable enclosure. The adjustable locking mechanism 10 can used, for example, on recreational or other vehicles such as, for example, on cabinet doors, cabin doors, drawers or luggage or other doors or compartments in vehicles or can be used in any other industrial, business, personal, travel or other vehicle or non-vehicle application. The adjustable locking mechanism 10 in accordance with the present disclosure, including each of these components, may have any suitable configuration other than as illustrated or described herein, and may include more or less components than as illustrated or described herein in accordance with other embodiments.

The illustrated housing 12 comprises a first portion 36 and a second portion 38. The first portion 36 includes a top portion 44 and a bottom portion 46 which define a central bore 48 receiving the lock cylinder 14. The top portion 44 includes a flanged outer wall 54 and an annular boss 56 that defines a plurality of indicia 60, shown in the form of four slots or marks disposed 90 degrees apart from each other. The top portion 44 also includes an annular ledge 62 disposed about the central bore 46 for engaging the lock cylinder 14. The bottom portion 46 includes an outer wall including a pair of threaded portions 72 and a pair of flat sides 74, and defines a slot 76 to receive the retainer 24.

The second portion 38 of the housing 12 has a generally truncated cylindrical configuration. The housing 12 includes an opening 80 defined by two opposed walls 82 and a lip 84. The opposed walls 82 are configured to limit rotation of the latching pawl 18. The housing defines a pair of holes 94 for engaging the cap 20. The housing 12 may be constructed of any suitable material, such as, for example, metal, synthetic materials or composite materials or any combination thereof. Among other materials, for example, a zinc alloy or any suitable polyurethane material may be suitable. The housing 12 may have any other suitable configuration in accordance with other embodiments.

The illustrated lock cylinder 14 is generally cylindrical and is rotatably coupled to the housing 12. The lock cylinder 14 includes a front face 96, a flange 98 for engaging the ledge 62 of the housing 12, a body portion 100 and a boss 102. The lock cylinder 14 defines a key hole slot 104 configured to align with the marks 60 defined by the housing 12 at alternative locations. The lock cylinder 14 also defines a cylinder recess 110 in the form of an annular groove for receiving the retainer 24. The lock cylinder 14 is rotatable by a key inserted into the key hole slot 104. The lock cylinder 14 is configured to be disengageable with the key in 90 degree rotational increments. For example, the lock cylinder 14 and housing 12 are configured such that the key can be inserted into the key hole slot 104 when the key hole slot 104 aligns with a pair of the marks 60, and becomes removable when the key hole slot is rotated 90 degrees or an increment of 90 degrees so that the key hole slot aligns with one of the pairs of marks. The degree of rotation and the location and number of marks 60 can be different than as described herein in accordance with other embodiments. Additionally, the marks 60 may be omitted in accordance with other embodiments. Still further, the key may be removable from any position or the lock cylinder 14 can be rotated without a key in accordance with other embodiments. The lock cylinder 14 may be constructed of any suitable material, such as metal, synthetic materials, composite materials or any combination thereof. Among other materials, for example, steel or other metal may be suitable. The lock cylinder 14 may have any other suitable configuration in accordance with other embodiments.

The illustrated latching pawl 18 includes a latch 120 and a ring 122 mounted to the spindle 16. The latch 120 extends through the opening 80 of the housing 12. The ring 122 includes a threaded inner wall 124 defining a hole 126 threadingly engaging the spindle 16. The latching pawl 18 is configured to rotate between an unlocked position, and a locked position in which it engages a wall or other structure adjacent or otherwise associated with the door, drawer or other enclosure. Because of the configuration of the opposing walls 82 of the housing 12, the degree of rotation of the latching pawl 18 is generally 90 degrees. The opposing walls 82 may be spaced or configured in any suitable manner to permit the 90 degree rotation or to permit degrees of rotation other than 90 degrees. The latching pawl 18 may be constructed of any suitable material, such as metal, synthetic materials, composite materials or any combination thereof. Among other materials, for example, steel or other metal may be suitable. The latching pawl 18 may have any other suitable configuration in accordance with other embodiments.

The illustrated spindle 16 includes a flange 130, a threaded portion 132, and an unthreaded portion 134, and is oriented along an axis 138. The flange 130 defines a recess 140 for receiving the boss 102 of the lock cylinder 14. The threaded portion 132 is configured to threadingly engage the latching pawl 18, and the unthreaded portion 134 is engaged with the cap 20. The unthreaded portion 134 of the spindle 16 defines a recess in the form of an annular groove 136 for receiving the retainer 26. The spindle 16 may be constructed of any suitable material, such as metal, synthetic materials, composite materials or any combination thereof. Among other materials, for example, steel or other metal has been found to be suitable. The spindle 16 may have any other suitable configuration in accordance with other embodiments.

The cap 20 illustrated in FIGS. 1, 3, 5 and 6 includes a base 150 and a rim 152. The base 150 defines a hole 154 for receiving the unthreaded portion 134 of the spindle 16. The retainer 26 is disposed about the spindle 16 immediately adjacent the hole 154. The retainer 26 and the cap 20 prevent or minimize any longitudinal displacement of the spindle relative to the housing 12. The rim 152 is comprised of a plurality of flexible fingers 160 for receiving the bottom portion 46 of the housing 12. At least some of the flexible fingers 160 terminate in a hook 168 configured to engage by snap fit the lip 84 of the second portion 38 of the housing 12. The hooks 168 are disposed about the cap 20 so that some of the hooks engage the lip 84 of the housing 12 and some are received by the holes 94 of the housing. The cap 20 may have any other suitable configuration in accordance with other embodiments.

The illustrated spring 22 is disposed about the spindle 16 between the first portion 36 of the housing 12 and the ring 122 of the latching pawl 18. The spring 22 applies a force biasing the latching pawl 1 8 away from the first portion 36 of the housing 12. The spring 22 is illustrated as a coil spring but may have any other suitable coil or non-coil configuration and may be positioned at any other suitable locations in accordance with other embodiments. The spring 22 may be constructed of any suitable material.

The other components of the illustrated embodiment, the retainers 24 and 26 and the locknut 28, are constructed of any suitable material. These components may have any other suitable configuration in accordance with other embodiments and may be omitted in accordance with other embodiments.

The adjustable locking mechanism 10 may be secured to a door, drawer or other suitable enclosure, for example, by installing it into a hole defined by the door, drawer or other suitable enclosure such that adjustable locking member extends through the hole, the front face 96 of the lock cylinder 14 faces away from one side of the door, drawer or other enclosure, and the latching pawl 18 is disposed on the other side of the door, drawer or other enclosure.

To unlock or disengage the adjustable locking mechanism 10 and thereby unlock or otherwise disengage the latch 120 from the wall or other structure associated with the door, drawer or other enclosure, a key may be inserted into the key hole slot 104 of the lock cylinder 14 and rotated approximately 90 degrees. The key hole slot 104 aligns with a first pair of the marks 60 prior to such rotation, and aligns with a second pair of the marks 60 at the conclusion of such rotation. The 90 degree rotation of the key causes the lock cylinder 14, the spindle 16 and the latching pawl 18 to together rotate 90 degrees. One of the opposing walls 82 of the housing 12 contacts the latch 120 of the latching pawl 18 to prevent further rotation of the latching pawl beyond 90 degrees. During such rotation, the latch 120 rotates within the opening 80 from one of the walls 82 to the other wall 82 and away from the wall or other structure associated with the wall or other structure associated with the door, drawer or other enclosure. The key may then be removed from the key hole slot 104.

To lock or engage the adjustable locking mechanism 10 and thereby lock or otherwise engage the latch 120 with the wall or other structure associated with the door, drawer or other enclosure, the key may be inserted into the key hole slot 104 of the lock cylinder 14 and rotated approximately 90 degrees in the reverse direction until the key hole slot 104 again aligns with the first pair of the marks 60. The 90 degree rotation of the key in the reverse direction causes the lock cylinder 14, the spindle 16 and the latching pawl 18 to rotate 90 degrees in the reverse direction. The other of the opposing walls 82 of the housing 12 contacts the latch 120 to prevent further rotation of the latching pawl 18 beyond 90 degrees. Thus, during such rotation, the latch 120 rotates within the opening 80 from one of the opposing walls 82 to the other to engage the wall or other structure associated with the door, drawer or other enclosure. The key may then be removed from the key hole slot 104.

With the illustrated embodiment, before removing the key, however, the locking or engaging force of the adjustable locking mechanism 10 can be increased by continued rotation of the key beyond 90 degrees. Continuing such rotation causes the spindle 16 to rotate relative to the latching pawl 18 because the other of the opposing walls 82 is engaged with the latch 120 and thus prevents further rotation of the latching pawl and because of the threading engagement of the spindle 16 and the latching pawl. Such rotation of the spindle 16 relative to the latching pawl 18 causes the latching pawl to travel on the spindle along the axis 138 of the spindle towards the first portion 36 of the housing 12. If desired, the lock cylinder 14 can be further rotated in the reverse direction an additional 90 degrees so that the key hole slot 104 aligns with the other pair of marks 60, which causes still further movement of the latching pawl 18 and still further increases the locking or engaging force. The key may then be removed from the key hole slot 104.

Such ability to increase the engagement force of the adjustable locking mechanism in rotational increments of the lock cylinder may provide a better seal and may be useful not only to ensure a sufficient sealing force but also to increase the sealing force, as circumstances may dictate. Increasing the engagement force may be used not only to provide a tight seal during an initial use of the adjustable locking mechanism, but also, for example, to provide a tighter seal after the door, seals or surfaces of the door, or the adjustable locking mechanism becomes worn, shrinks, swells or otherwise changes over time.

With the illustrated adjustable locking mechanism 10, it is intended that the key be removable from the key hole slot 104 upon rotational increments of 90 degrees. In this regard, as indicated above, when unlocking or disengaging the adjustable locking mechanism 10, the key is rotated 90 degrees and then becomes removable; and when locking or engaging the adjustable locking mechanism 10, the key is rotated 90 degrees in the other direction and then becomes removable. Similarly, when the engaging or clamping force is increased, the key is removable after one or more 90 degree incremental rotations. Any other suitable magnitude of rotation can be used in accordance with other embodiments. Moreover, it is not necessary that the key be removable at any certain location or that a key even be used to rotate the lock cylinder in accordance with other embodiments.

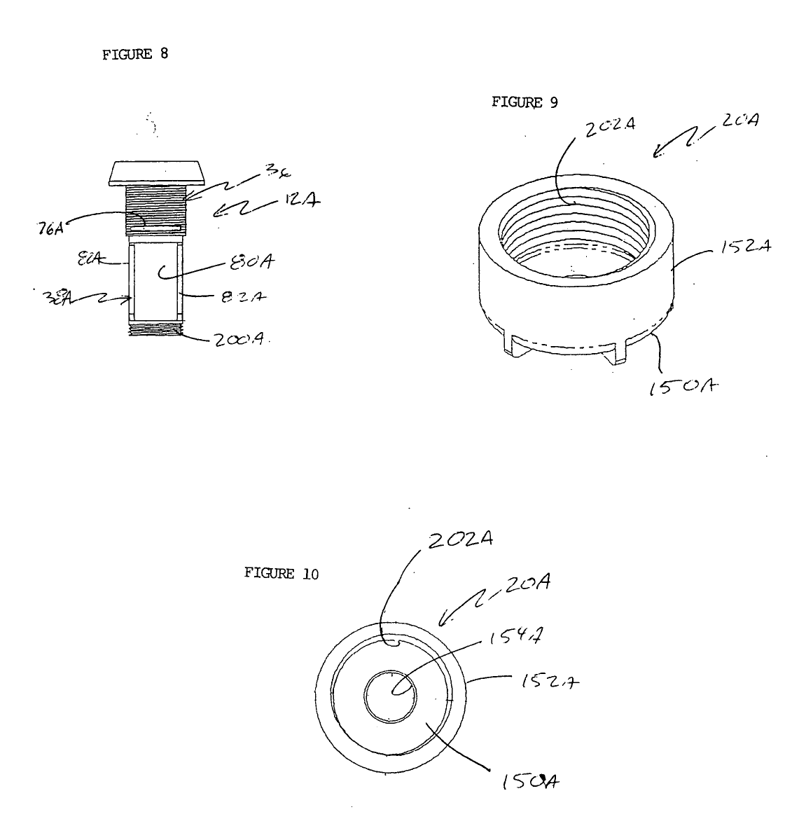

FIGS. 7-10 illustrate alternative embodiments of the housing and the cap, which are threadingly engaged with each other. The housing 12A illustrated in FIGS. 7 and 8 is similar to the housing 12 except that the second portion 36A includes a threaded base 200A for threadingly engaging the cap 20A of FIGS. 9 and 10. The illustrated cap includes a base 150A and a rim 152A. The base 150A defines a hole 154A for receiving the unthreaded portion 142 of the spindle 16. The rim 152A includes a threaded inner wall 202A for threadingly engaging the threaded portion of the bottom of the housing 12A. The housing 12A and the cap 20 may have any suitable configuration in accordance with other embodiments.

The present disclosure also relates to a method for adjustably engaging and disengaging the door, drawer or other enclosure with the structure associated with the enclosure comprising rotating a lock cylinder of a locking mechanism in a first direction to cause a latch of the locking mechanism to engage the structure; and rotating the lock cylinder further in the first direction to cause the latch to increase the engaging force on the structure. The locking mechanism may be in the form of the adjustable locking mechanism 10 described above or may have any other suitable construction.

Although the adjustable locking mechanism of the present disclosure has been described and illustrated in detail with reference to preferred embodiments, it is to be clearly understood that the same is by way of illustration and example only, and is not to be taken by way of limitation. The spirit and scope of the present disclosure are to be limited only by terms of the appended claims.

1. An adjustable locking mechanism for use with an enclosure, comprising:
a housing defining an opening;
a spindle oriented along an axis;
a latching pawl coupled to the spindle, the latching pawl including a latch extending through the opening of the housing, the latching pawl rotatable with the spindle relative to the housing between a first position and a second position in which the latch is configured to engage structure associated with the enclosure, the latching pawl and spindle rotatable relative to the housing alternatively in a first direction toward the first position and in a second direction toward the second position; and
a lock cylinder coupled to the spindle and rotatably coupled to the housing, the lock cylinder configured to cause rotation of the spindle and the latching pawl relative to the housing alternatively in the first and second directions, the lock cylinder configured to provide continued rotation of the spindle in the second direction when the latching pawl has been rotated to the second position to cause rotation of the spindle relative to the latching pawl and to thereby cause movement of the latching pawl along the axis of orientation of the spindle.

2. The adjustable locking mechanism of claim 1 wherein the spindle is threadingly engaged with the latching pawl.

3. The adjustable locking mechanism of claim 1 further comprising a spring coupled to the spindle and the latching pawl biasing the latching pawl against such movement along the axis of orientation of the spindle.

4. The adjustable locking mechanism of claim 3 wherein the spring is a coil spring disposed about the spindle.

5. The adjustable locking mechanism of claim 4 wherein the spring is disposed between the locking pawl and the lock cylinder.

6. The adjustable locking mechanism of 1 wherein the housing defines a bore receiving the lock cylinder.

7. The adjustable locking mechanism of claim 1 wherein the housing includes two walls defining the opening and configured to limit rotation of the latching pawl, the latching pawl contacting one of the walls when it is in the first position and contacting the other of the walls when it is in the second position.

8. The adjustable locking mechanism of claim 7 wherein the walls extend substantially parallel to the axis of the spindle.

9. The adjustable locking mechanism of claim 7 wherein the degree of rotation of the lock cylinder between the first and second positions of the latching pawl is 90 degrees.

10. The adjustable locking mechanism of claim 1 wherein the opening is configured such that the degree of rotation of the lock cylinder between the first and second positions of the latching pawl is 90 degrees.

11. The adjustable locking mechanism of claim 1 wherein the lock cylinder defines a key hole slot and wherein the housing defines a plurality of indicia configured to align with the key hole slot at alternative positions to designate different rotational positions of the lock cylinder relative to the housing.

12. The adjustable locking mechanism of claim 11 wherein the indicia are disposed 90 degrees apart from each other.

13. The adjustable locking mechanism of claim 1 wherein the spindle defines a recess and the lock cylinder includes a boss received by the recess coupling the spindle and the lock cylinder.

14. The adjustable locking mechanism of claim 1 wherein the spindle includes a top defining a recess and the lock cylinder includes a boss received by the recess coupling the spindle and the lock cylinder.

15. The adjustable locking mechanism of claim 1 wherein the spindle has a bottom end and wherein the adjustable locking mechanism further comprises a cap coupled to the bottom end.

16. The adjustable locking mechanism of claim 15 wherein the cap is removably coupled to the bottom end.

17. The adjustable locking mechanism of claim 15 wherein the cap is removably coupled to the bottom end by snap fit.

18. The adjustable locking mechanism of claim 15 wherein the cap is threadingly engaged with the bottom end.

19. An adjustable locking mechanism for an enclosure comprising:
a housing;
a spindle oriented along an axis;
a latching pawl threadingly engaged with the spindle, the latching pawl including a latch, the latching pawl rotatable with the spindle relative to the housing between a first and a second position in which the latch is configured to engage structure associated with the door, drawer or other enclosure, the latching pawl and spindle rotatable relative to the housing alternatively in a first direction toward the first position and in a second direction toward the second position; and
means for rotating the spindle relative to the housing alternatively in first and second directions, the rotating means configured to cause rotation of the latching pawl between the first and second directions and to permit continued rotation of the spindle in the second direction when the latching pawl has been rotated to the second position to cause rotation of the spindle relative to the latching pawl and to thereby cause movement of the latching pawl along the axis of orientation of the spindle.

20. The spindle of claim 19 wherein the rotating means includes a lock cylinder rotatably coupled to the housing.

21. The spindle of claim 20 wherein the rotating means further includes a pair of walls of the housing defining an opening receiving the latch and configured to limit rotation of the latching pawl.

22. The spindle of claim 19 further comprising a spring disposed about the spindle.

23. An adjustable locking mechanism for an enclosure comprising:
a housing defining a bore and an opening;
a spindle oriented along an axis;
a coil spring disposed about the spindle;
a latching pawl coupled to the spring and threadingly engaged with the spindle, the latching pawl including a latch extending through the opening of the housing, the latching pawl rotatable with the spindle relative to the housing between a first position and a second position in which the latch is configured to engage structure associated with the enclosure, the latching pawl and spindle rotatable relative to the housing alternatively in a first direction toward the first position and in a second direction toward the second position; and
a lock cylinder received by the bore of the housing and coupled to the spindle, the lock cylinder configured to cause rotation of the spindle and the latching pawl relative to the housing alternatively in the first and second directions, the lock cylinder configured to permit continued rotation of the spindle in the second direction when the latching pawl has been rotated to the second position to cause rotation of the spindle relative to the latching pawl and to thereby cause movement of the latching pawl along the axis of orientation of the spindle.

24. The adjustable locking mechanism of claim 23 wherein the housing includes two walls defining the opening configured to limit rotation of the latching pawl, the latching pawl contacting one of the walls when it is in the first position and contacting the other of the walls when it is in the second position.

25. The adjustable locking mechanism of claim 24 wherein the walls are positioned such that the degree of rotation of the lock cylinder between the first and second positions of the latching pawl is 90 degrees.

26. The adjustable locking mechanism of claim 23 further comprising a cap removably engaged with an end of the spindle.

27. A method for adjustably engaging and disengaging a door with structure associated with the door comprising:
(a) rotating a lock cylinder of a locking mechanism in a first direction to cause a latch of the locking mechanism to engage the structure;
(b) rotating the lock cylinder further in the first direction to cause the latch to increase the engaging force on the structure.

28. The method of claim 27 wherein the latch is threadingly engaged with a spindle of the locking mechanism and during (b) the spindle rotates to cause the latch to move along an axis of orientation of the spindle.

29. The method of claim 28 further including:
(c) rotating the lock cylinder in a second direction to cause the latch of the locking mechanism to disengage the structure.

30. The method of claim 29 wherein during (a) the degree of rotation of the lock cylinder in the first direction has a first magnitude, during (b) the degree of further rotation of the lock cylinder in the first direction has a second magnitude, and during (c) the degree of rotation of the lock cylinder in the second direction has a third magnitude.

31. The method of claim 30 wherein the first and third magnitudes are substantially the same.

32. The method of claim 29 wherein during (a) the degree of rotation of the lock cylinder in the first direction has a magnitude, and during (c) the degree of rotation of the lock cylinder in the second direction also has said magnitude.

33. The method of claim 32 wherein a key is used to rotate the lock cylinder during (a), (b) and (c) and the key is removable from the lock cylinder in rotational increments equal to said magnitude.

34. The method of claim 33 wherein said magnitude is 90 degrees.
